(19) United States
(12) Patent Application Publication
(10) Pub. No.: US 2012/0326006 A1
(43) Pub. Date: Dec. 27, 2012

(54) OBJECT DETECTING DEVICE AND INFORMATION ACQUIRING DEVICE

(75) Inventor: Nobuo IWATSUKI, Anpachi-Gun (JP)

(73) Assignee: Sanyo Electric Co., Ltd., Moriguchi-shi (JP)

(21) Appl. No.: 13/605,578

(22) Filed: Sep. 6, 2012

Related U.S. Application Data
(63) Continuation of application No. PCT/JP2012/057273, filed on Mar. 22, 2012.

(30) Foreign Application Priority Data
Mar. 29, 2011 (JP) 2011-73420

(51) Int. Cl. G01J 1/44

(52) U.S. Cl. 250/206

(57) ABSTRACT

An information acquiring device is provided with a light emitting device, a light receiving device, and a base member on which the light emitting device and the light receiving device are mounted side by side. The light emitting device is provided with a laser light source, a collimator lens, a light separating element which reflects a part of laser light and transmits a part of the laser light, a diffractive optical element which converts the reflected laser light into laser light having a dot pattern, a photodetector which receives the transmitted laser light, and a laser controller which controls a light emission amount of the laser light source based on a detection signal from the photodetector. The laser light source, the collimator lens and the light separating element are linearly arranged, and the diffractive optical element faces a target area.

This application claims priority under 35 U.S.C. Section 119 of Japanese Patent Application No. 2011-73420 filed Mar. 29, 2011, entitled “OBJECT DETECTING DEVICE AND INFORMATION ACQUIRING DEVICE”. The disclosure of the above application is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to irradiate a target area with laser light having a predetermined dot pattern is operable to receive reflected light of laser light having a dot pattern reflected on the target area by a light receiving element. Then, a distance to each portion of an object to be detected (an irradiation position of each dot on an object to be detected) is detected, based on a light receiving position of each dot on the light receiving element, using a triangulation method (see e.g. pp. 1279-1280, the 19th Annual Conference Proceedings (Sep. 18-20, 2001) by the Robotics Society of Japan).

In the distance image sensor thus constructed, a laser light source, a collimator lens, and a diffractive optical element are used as optical elements for projecting laser light having a dot pattern. Among these optical elements, the emission light amount of the laser light source changes resulting from heat radiation or aging deterioration. In view of the above, it is necessary to monitor the output of laser light and perform APC (Auto Power Control) (hereinafter, called as APC control) so that an intended light output level is obtained.

In the APC control, there may be used an arrangement of a so-called back monitor system, wherein a photodetector is provided in a CAN of a laser light source. In this arrangement, laser light emitted from the back surface side of a laser element is received by the photodetector in the CAN. However, as miniaturization of the laser light source progresses accompanied by miniaturization of an object detecting device, the diameter of the CAN decreases, which may make it difficult to accommodate the photodetector within the CAN. If such a condition occurs, it is impossible to apply the arrangement of the back monitor system to the APC control.

### SUMMARY OF THE INVENTION

A first aspect of the invention is directed to an information acquiring device. The information acquiring device according to the first aspect is provided with a light emitting device which irradiates a target area with laser light having a dot pattern; a light receiving device which captures an image of the target area; and a base member on which the light emitting device and the light receiving device are mounted side by side. The light emitting device includes a laser light source; a collimator lens which converts laser light emitted from the laser light source into parallel light; a light separating element which reflects a part of the laser light transmitted through the collimator lens, and transmits a part of the laser light; a diffractive optical element which converts the laser light reflected on the light separating element into laser light having a predetermined dot pattern in the target area for projecting onto the target area; a photodetector which receives the laser light transmitted through the light separating element for outputting a detection signal in accordance with a received light amount; and a laser controller which controls a light emission amount of the laser light source, based on the detection signal from the photodetector. The light emitting device is configured to dispose the laser light source, the collimator lens, the light separating element, the photodetector and the diffractive optical element on the base member in such a manner that the laser light source, the collimator lens and the light separating element are linearly arranged, and that the diffractive optical element faces the target area.

A second aspect of the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIG. 4 is an exploded perspective view of a light emitting device in the embodiment.

FIGS. 5A and 5B are perspective views showing an arrangement of the light emitting device in the embodiment.

FIG. 6 is a diagram showing an assembling process of the information acquiring device in the embodiment.

FIG. 7 is a diagram showing the assembling process of the information acquiring device in the embodiment.

FIGS. 8A and 8B are diagrams showing the assembling process of the information acquiring device in the embodiment.

FIGS. 9A and 9B are diagrams respectively showing an arrangement of the information acquiring device in the embodiment and an arrangement of an information acquiring device in a comparative example.

FIG. 10 is a flowchart showing an APC control to be performed by the information acquiring device in the embodiment.

FIGS. 11A and 11B are diagrams showing modification examples of the information acquiring device in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, there is exemplified an information acquiring device for irradiating a target area with laser light having a predetermined dot pattern.

In the embodiment, an APC controller 21b corresponds to a “laser controller” in the claims. A leakage mirror 130 corresponds to a “light separating element” in the claims. A DOE 140 corresponds to a “diffractive optical element” in the claims. An FMD 150 corresponds to a “photodetector” in the claims. A mirror mounting portion 160a corresponds to a “light separating element holding portion” in the claims. An FMD mounting portion 160c corresponds to a “photodetector mounting portion” in the claims. Abase plate 300 corresponds to a “base member” in the claims. The description regarding the correspondence between the claims and the embodiment is merely an example, and the claims are not limited by the description of the embodiment.

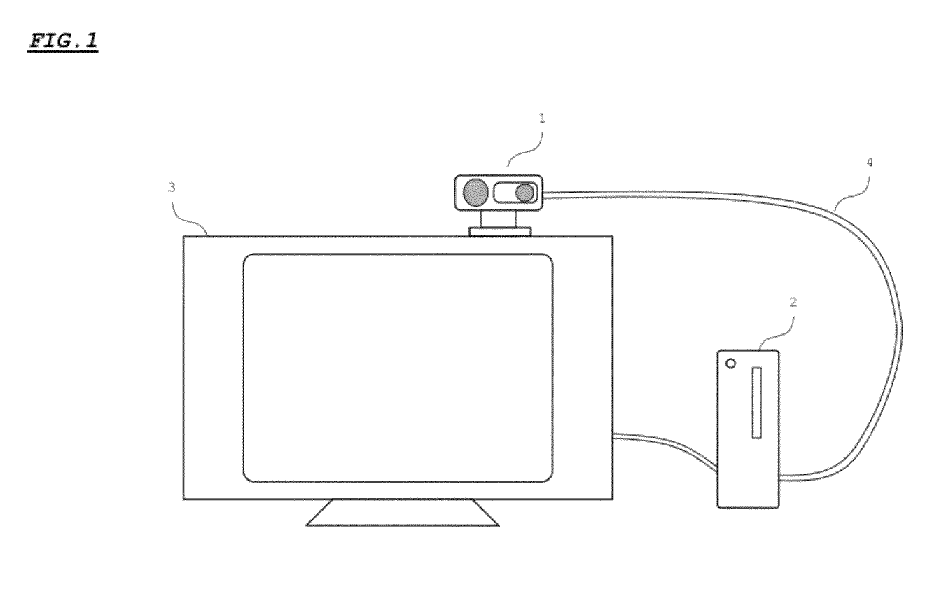

A schematic arrangement of an object detecting device according to the first embodiment is described. As shown in FIG. 1, the object detecting device is provided with an information acquiring device 1, and an information processing device 2. A TV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

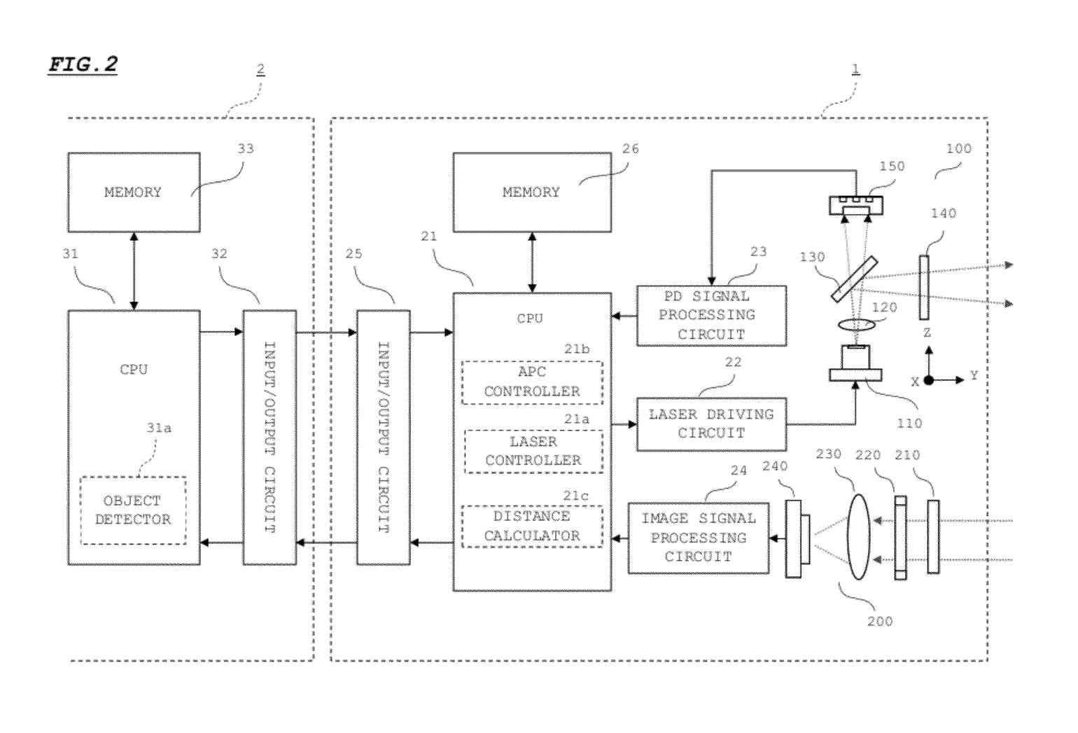

FIG. 2 is a diagram showing an arrangement of the information acquiring device 1 and the information processing device 2. In FIG. 2, to simplify the description, XYZ axes orthogonal to each other are shown to indicate directions regarding a projection optical system 100 and a light receiving optical system 200.

The information acquiring device 1 is provided with the projection optical system 100 and the light receiving optical system 200 which constitute an optical section. The projection optical system 100 and the light receiving optical system 200 are provided in the information acquiring device 1 to be aligned in Z-axis direction.

The projection optical system 100 is provided with a laser light source 110, a collimator lens 120, and a leakage mirror 130, a DOE (Diffractive Optical Element) 140, and an FMD (Front Monitor Diode) 150. Further, the light receiving optical system 200 is provided with a filter 210, an aperture 220, an imaging lens 230, and a CMOS image sensor 240. In addition to the above, the information acquiring device 1 is provided with a CPU (Central Processing Unit) 21, a laser driving circuit 22, a PD signal processing circuit 23, an image signal processing circuit 24, an input/output circuit 25, and a memory 26, which constitute a circuit section.

The laser light source 110 outputs laser light having a narrow wavelength band of about 830 nm in a direction (plus Z-axis direction) away from the light receiving optical system 200. The collimator lens 120 converts the laser light emitted from the laser light source 110 into light (hereinafter, simply called as “parallel light”) slightly expanded from parallel light.

The leakage mirror 130 is composed of multilayered dielectric films, and the number of film layers and the layer thickness are designed in such a manner that the reflectance of the leakage mirror 130 is set slightly smaller than 100%, and the transmittance thereof is set several times as small as the reflectance (for instance, reflectance: 95%, transmittance: 5%). The leakage mirror 130 reflects a main part of laser light entered from the collimator lens 120 side in a direction (Y-axis direction) toward the DOE 140, and transmits a part of the remainder of the laser light in a direction (Z-axis direction) toward the FMD 150. The laser light source 110 is required to emit a large amount of light for irradiating a target object located afar. It is desirable to set the transmittance of the leakage mirror 130 to a small value to some extent so that a large amount of laser light reflected on the FMD 150 to be described later may not enter the laser light source 110 along an optical path at the time of light incidence.

The DOE 140 has a diffraction pattern on a light incident surface thereof. Laser light entered to the DOE 140 is converted into laser light having a dot pattern by a diffractive action of the diffraction pattern, and is irradiated onto a target area. The diffraction pattern has e.g. a structure such that a step-type diffraction hologram is formed with a predetermined pattern. The pattern and the pitch of the diffraction hologram are adjusted in such a manner that laser light collimated by the collimator lens 120 as parallel light is converted into laser light having a dot pattern.

The DOE 140 irradiates a target area with laser light entered from the leakage mirror 130 as laser light having a radially spreading dot pattern. The size of each dot of the dot pattern corresponds to the beam size of laser light to be entered to the DOE 140. Laser light (zero-th order light) which is not diffracted by the DOE 140 is transmitted through the DOE 140 and travels in a forward direction.

The FMD 150 receives laser light transmitted through the leakage mirror 130, and outputs an electric signal in accordance with a received light amount.

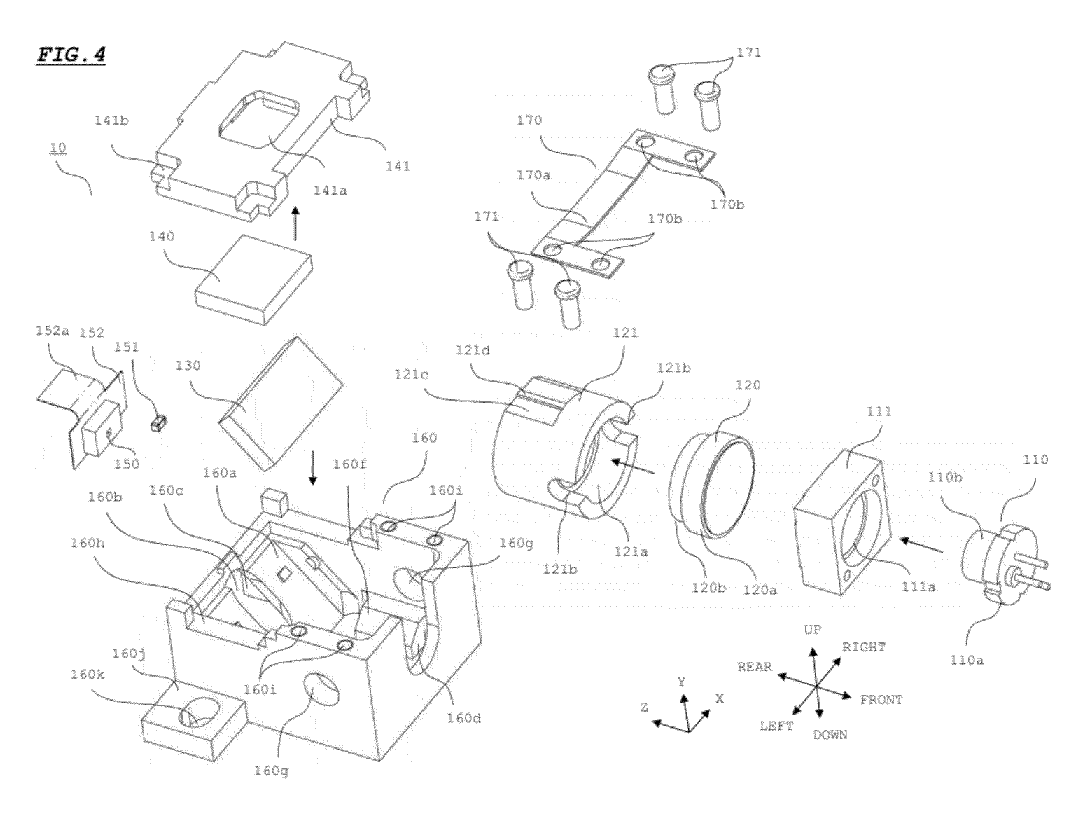

The detailed arrangement of the projection optical system 100 will be described later referring to FIGS. 4 through 8B.

Laser light reflected on a target area is entered to the imaging lens 230 via the filter 210 and the aperture 220.

The filter 210 is a band-pass filter which transmits light of a wavelength band including the emission wavelength (of about 830 nm) of the laser light source 110, and blocks light of a wavelength band of visible light. The aperture 220 converts external light into convergent light in accordance with the F-number of the imaging lens 230. The imaging lens 230 condenses the light entered through the aperture 220 on the CMOS image sensor 240.

The CMOS image sensor 240 receives light condensed on the imaging lens 230, and outputs a signal (electric charge) in accordance with a received light amount to the image signal processing circuit 24 pixel by pixel. In this example, the CMOS image sensor 240 is configured in such a manner that the output speed of signals to be outputted from the CMOS image sensor 240 is set high so that a signal (electric charge) at each pixel can be outputted to the image signal processing circuit 24 with high response from a light receiving timing at each pixel.

The CPU 21 controls the parts of the information acquiring device 1 in accordance with a control program stored in the memory 26. By the control program, the CPU 21 has functions of a laser controller 21a for controlling the laser light source 110, an APC controller 21b for performing so-called APC control i.e. performing automatic control of the light amount of the laser light source 110 in accordance with a signal amount outputted from the FMD 150, and a distance calculator 21c for generating three-dimensional distance information.

The laser driving circuit 22 drives the laser light source 110 in accordance with a control signal from the CPU 21.

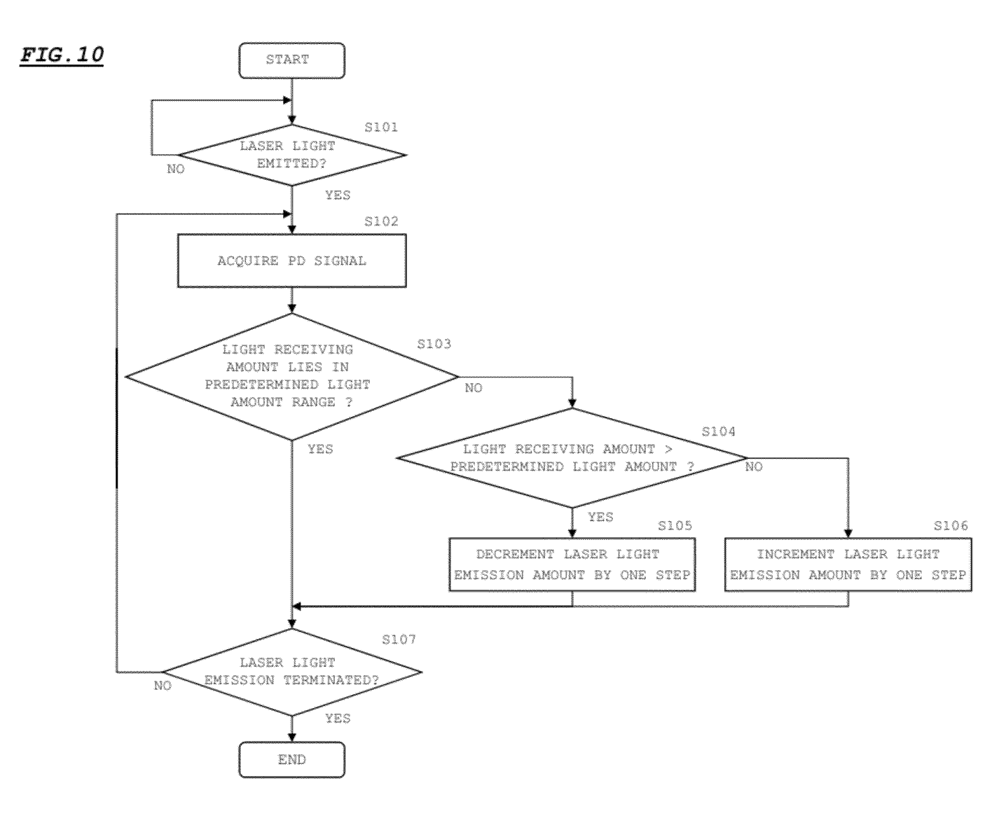

The PD signal processing circuit 23 amplifies and digitizes a voltage signal in accordance with a received light amount outputted from the FMD 150 for outputting to the CPU 21. The CPU 21 determines whether to increase or decrease the light amount of the laser light source 110 by a processing to be performed by the APC controller 21b, based on a signal to be supplied from the PD signal processing circuit 23. In the case where it is determined that it is necessary to change the light amount of the laser light source 110 by the APC controller 21b, the laser controller 21a transmits, to the laser driving circuit 22, a control signal for changing the light emission amount of the laser light source 110. The processing relating to APC control will be described later referring to FIG. 10. The image signal processing circuit 24 controls the CMOS image sensor 240 to successively read signals (electric charges) from the pixels, which have been generated in the CMOS image sensor 240, line by line. Then, the image signal processing circuit 24 outputs the read signals successively to the CPU 21. The CPU 21 calculates a distance from the information acquiring device 1 to each portion of an object to be detected, by a processing to be implemented by the distance calculator 21c, based on the signals (image signals) to be supplied from the image signal processing circuit 24. The input/output circuit 25 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

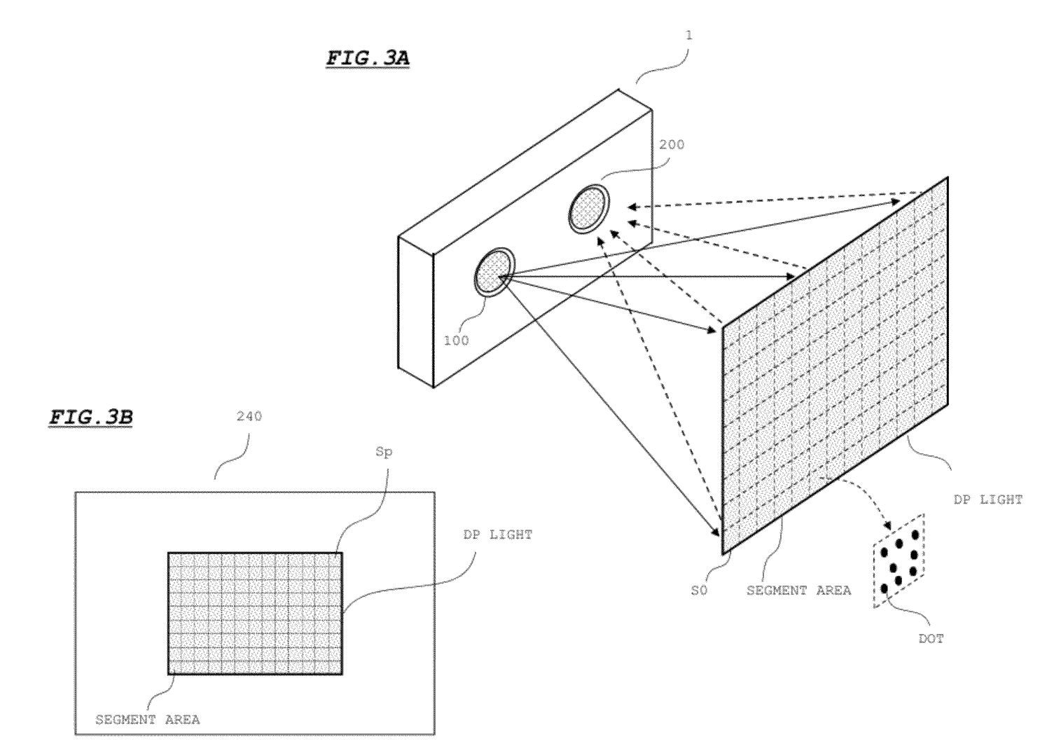

FIG. 3A is a diagram schematically showing an irradiation state of laser light onto a target area. FIG. 3B is a diagram schematically showing a light receiving state of laser light on the CMOS image sensor 240. To simplify the description, FIG. 3B shows a light receiving state in the case where a flat plane (screen) is disposed on a target area.

The projection optical system 100 irradiates a target area with laser light having a dot pattern (hereinafter, the entirety of the laser light having the dot pattern is called as “DP light”). FIG. 3A shows a light flux area of DP light by a solid-line frame. In the light flux of DP light, dot areas (hereinafter, simply called as “dots”) in which the intensity of laser light is increased by a diffractive action of the DOE 140 locally appear in accordance with the dot pattern by the diffractive action of the DOE 140.

To simplify the description, in FIG. 3A, a light flux of DP light is divided into segment areas arranged in the form of a matrix. Dots locally appear with a unique pattern in each segment area. The dot appearance pattern in a certain segment area differs from the dot appearance patterns in all the other segment areas. With this configuration, each segment area is identifiable from all the other segment areas by a unique dot appearance pattern of the segment area.

When a flat plane (screen) exists in a target area, the segment areas of DP light reflected on the flat plane are distributed in the form of a matrix on the CMOS image sensor 240, as shown in FIG. 3B. For instance, light of a segment area S0 in the target area shown in FIG. 3A is entered to a segment area Sp shown in FIG. 3B, on the CMOS image sensor 240. In FIG. 3B, a light flux area of DP light is also indicated by a solid-line frame, and to simplify the description, a light flux of DP light is divided into segment areas arranged in the form of a matrix in the same manner as shown in FIG. 3A.

The distance calculator 21c is operable to detect a position of each segment area on the CMOS image sensor 240 for detecting a distance to a position of an object to be detected corresponding to the segment area, based on the detected position of the segment area, using a triangulation method. The details of the above detection method is disclosed in e.g. pp. 1279-1280, the 19th Annual Conference Proceedings (Sep. 18-20, 2001) by the Robotics Society of Japan.

As shown in FIG. 2, if the projection optical system 100 is configured to bend the optical path of laser light emitted from the laser light source 110 at a certain position in such a direction as to direct the laser light toward the DOE 140, it is possible to reduce the thickness of the information acquiring device 1 in a projecting direction of light toward a target area. In this arrangement, if the thickness reduction of the information acquiring device 1 progresses, the space for loading a laser light source in the information acquiring device 1 decreases, and the diameter of the CAN of the laser light source 110 also decreases. If the diameter of the CAN of the laser light source 110 decreases as described above, however, it is difficult to dispose a photodetector for APC control within the CAN.

In view of the above, the embodiment proposes an arrangement, wherein the leakage mirror 130 is used as a mirror for bending the optical path of laser light, laser light leaked from the leakage mirror 130 is received on the FMD 150, and APC control is performed by a detection signal from the FMD 150. This arrangement enables to perform APC control of the laser light source 110, while miniaturizing the information acquiring device 1.

FIG. 4 is an exploded perspective view showing an arrangement example of a light emitting device 10 in the embodiment. The light emitting device 10 is a device constructed by assembling the projection optical system 100 shown in FIG. 2 and other components into one unit. In FIG. 4, front and rear directions, left and right directions, and up and down directions are indicated along with XYZ axes shown in FIG. 2. Up and down directions are in parallel to Y-axis direction, left and right directions are in parallel to X-axis direction, and front and rear directions are in parallel to Z-axis direction.

Referring to FIG. 4, the light emitting device 10 is provided with a laser holder 111, a lens holder 121, a DOE holder 141, a capacitor 151, an FMD circuit board 152, a housing 160, and a pressing spring 170, in addition to the laser light source 110, the collimator lens 120, the leakage mirror 130, the DOE 140, and the FMD 150.

As shown in FIG. 4, the laser light source 110 has a base member 110a and a CAN 110b. The base member 110a has a circular shape in front view, with the outer circumference thereof being partially cut away. Further, the collimator lens 120 has a large diametrical portion 120a with a cylindrical outer circumferential surface, and a small diametrical portion 120b with a diameter thereof smaller than that of the large diametrical portion 120a.

The laser holder 111 has a square shape in front view, and is made of a frame member with a circular opening 111a formed in the center thereof. The opening 111a passes through the laser holder 111 in front and rear directions, and is so configured that two cylindrical holes with the diameters thereof different from each other are coaxially aligned. The diameter of the front hole of the opening 111a is set larger than the diameter of the rear hole of the opening 111a, and a ring-shaped step portion is formed on a boundary portion where the diameter changes. The diameter of the front hole of the opening 111a is set slightly larger than the diameter of the base member 110a of the laser light source 110. The laser light source 110 is positioned relative to the laser holder 111 by inserting the base member 110a into the opening 111a from the front side to such an extent that a rear surface of the base member 110a of the laser light source 110 is abutted against the step portion in the opening 111a. In this state, an adhesive is applied in the cutaway formed in the outer circumference of the base member 110a, whereby the laser light source 110 is adhesively fixed to the laser holder 111.

The laser holder 111 is made of a material having a high heat conductivity such as zinc, and is manufactured by a general die-cast molding.

The lens holder 121 has a substantially circular shape in front view, and is made of a frame member with an opening 121a formed in the center thereof. The opening 121a passes through the lens holder 121 in front and rear directions, and is so configured that two cylindrical holes with the diameters thereof different from each other are coaxially aligned. The diameter of the front hole of the opening 121a is set larger than the diameter of the rear hole of the opening 121a, and a ring-shaped step portion is formed on a boundary portion where the diameter changes. The diameter of the front hole of the opening 121a is set slightly larger than the diameter of the large diametrical portion 120a of the collimator lens 120. The collimator lens 120 is positioned relative to the lens holder 121 by inserting the large diametrical portion 120a into the opening 121a from the front side to such an extent that a rear surface of the large diametrical portion 120a of the collimator lens 120 is abutted against the step portion in the opening 121a. In this state, the collimator lens 120 is adhesively fixed to the lens holder 121.

A recess 121c extending in front and rear directions is formed in a top surface of the lens holder 121. A protrusion 121d extending in front and rear directions is formed on the recess 121c. Two grooves 121b are formed on side of the lens holder 121 so that an adhesive is allowed to flow in adhesively fixing the collimator lens 120 and the lens holder 121 to each other.

A rectangular groove 121e linearly extending in left and right directions (X-axis direction) is formed in a lower surface of the lens holder 121 (not shown). The groove 121e is used in adjusting the position of the lens holder 121 in front and rear directions (Z-axis direction). The center of the protrusion 121d and the center of the groove 121e in a circumferential direction of the lens holder 121 are displaced from each other by 180 degrees. Accordingly, when the protrusion 121d faces right above, the groove 121e faces right below.

A step portion (not shown) for mounting the DOE 140 is formed on a lower surface of the DOE holder 141. Further, an opening 141a for guiding laser light toward a target area is formed in the center of the DOE holder 141. The DOE 140 is inserted into the DOE holder 141 from beneath the DOE holder 141, and is adhesively fixed to the DOE holder 141. Further, a step portion 141b for fixing the DOE holder 141 in the housing 160 is formed at left and right ends of the DOE holder 141.

The capacitor 151 reduces electrical noise generated in the FMD circuit board 152. The FMD circuit board 152 is a circuit board for carrying the FMD 150 and the capacitor 151 thereon. The FMD circuit board 152 is mounted with various circuits such as the PD signal processing circuit 23 shown in FIG. 2, an amplifying circuit for amplifying an electrical signal outputted from the FMD 150, and an A/D conversion circuit for analog-to-digital conversion. Further, the FMD circuit board 152 is provided with, at a rear position thereof, an FPC (Flexible Printed Circuit) 152a to be electrically connected to a circuit board which is disposed posterior to the FMD circuit board 152 and carrying the CPU 21 and the like.

The housing 160 has a rectangular shape in top plan view, and is made of a frame member having a bottom surface. The housing 160 is symmetrical in left and right directions with respect to a plane in parallel to Y-Z plane, except for portions where screw holes 160k are formed. The housing 160 is made of a material having a high heat conductivity, and is manufactured by a general die-cast molding.

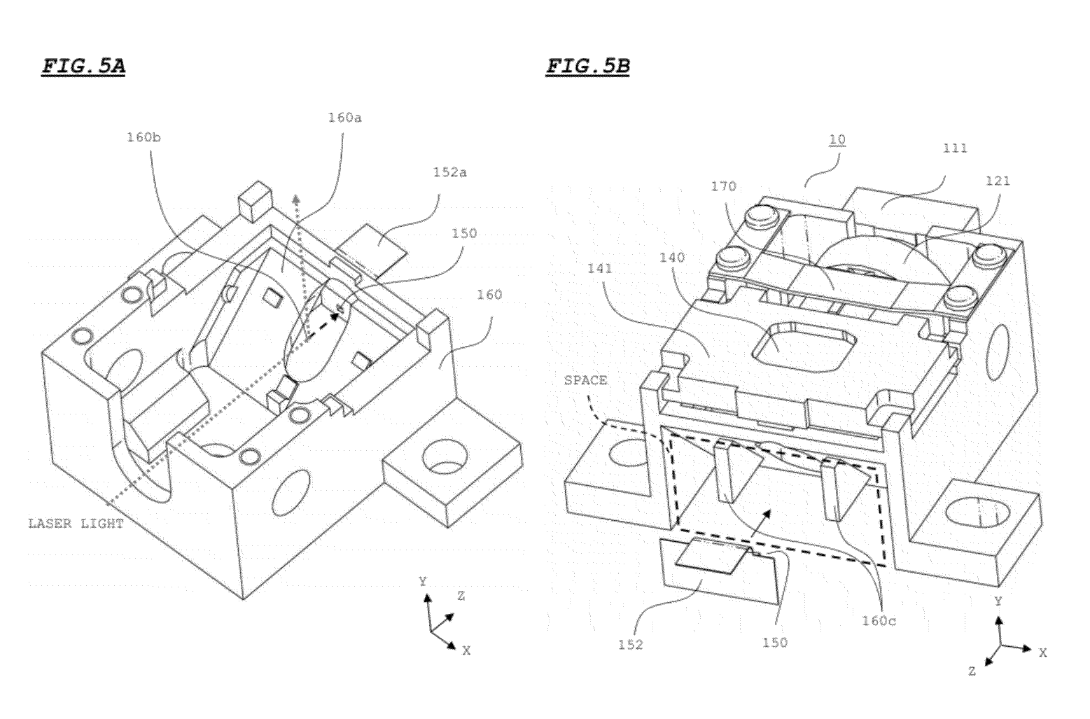

As shown in FIG. 4, a mirror mounting portion 160a with an inclination of 45° in an in-plane direction of Y-Z plane is formed on an inner rear portion of the housing 160. A U-shaped opening 160b is formed in the mirror mounting portion 160a. Further, an FMD mounting portion 160c protruding in a rear direction (Z-axis direction) is formed on aback surface of the mirror mounting portion 160a (see FIG. 5B).

The FMD 150 is mounted on the FMD mounting portion 160c in such a manner that a light receiving surface of the FMD 150 extends perpendicular to the optical axis of the laser light source 110. Specifically, the FMD circuit board 152 carrying the FMD 150 and the capacitor 151 is positioned on the FMD mounting portion 160c and is adhesively fixed thereto. FIG. 5A is a perspective view showing a state that the FMD circuit board 152 is adhesively fixed to the FMD mounting portion 160c. In FIG. 5A, to simplify the description, illustration of the optical components to be housed in the housing 160 is omitted.

The leakage mirror 130 is mounted on the mirror mounting portion 160a, and is adhesively fixed thereto. Further, a U-shaped opening 160d is formed in a front side surface of the housing 160. The width of the opening 160d in left and right directions is set larger than the diameter of the CAN 110b of the laser light source 110.

A hole 160e for guiding a Z-axis adjusting jig (not shown) into the groove 121e of the lens holder 121 is formed in the bottom surface of the housing 160 (not shown). The diameter of the hole 160e is set larger than the Z-axis directional width of the groove 121e of the lens holder 121. Two holes 160g are formed in two respective side surfaces of the housing 160 aligned in left and right directions so that a UV adhesive is allowed to flow into the housing 160.

Further, a pair of slopes 160f facing each other is formed on lower ends of two inner side surfaces of the housing 160 aligned in left and right directions. The two slopes 160f are inclined downwardly at a certain angle with respect to a plane in parallel to X-Z plane. Displacement of the lens holder 121 in X-axis direction (left and right directions) is restricted by placing the lens holder 121 on the two slopes 160f.

Step portions 160h for mounting the DOE holder 141, and four screw holes 160i are formed on a top surface of the housing 160. The Z-axis directional width of each step portion 160h is set slightly larger than the width of the left/right step portion 141b of the DOE holder 141. Two flange portions 160j protruding outwardly of the housing 160 are respectively formed at lower ends of two outer side surfaces of the housing 160 aligned in left and right directions. Each of the two flange portions 160j is formed with the screw hole 160k for fixing the housing 160 onto the base plate 300 to be described later.

The pressing spring 170 is a resilient plate spring, and has a step portion 170a lower than the other portion by one step in the middle thereof. The pressing spring 170 has a symmetrical configuration in left and right directions. Four screw holes 170b for fixing the pressing spring 170 onto the housing 160 from above are formed in the pressing spring 170.

Referring to FIG. 4, in assembling the light emitting device 10, firstly, the leakage mirror 130 is mounted on the mirror mounting portion 160a within the housing 160. By performing the above operation, the leakage mirror 130 is installed in the housing 160 with an inclination of 45 degrees in an in-plane direction of Y-Z plane with respect to X-Z plane.

Then, the lens holder 121 carrying the collimator lens 120 is placed on the paired slopes 160f in such a state that the groove 121e and the hole 160e are aligned with each other, whereby the lens holder 121 is housed within the housing 160. In the installation, the groove 121e and the hole 160g are aligned with each other by placing the lens holder 121 on the slopes 160f in such a manner that the protrusion 121d faces right above.

Then, the pressing spring 170 is abutted against an upper portion of the housing 160 in such a manner that the four screw holes 170b of the pressing spring 170 are aligned with the four screw holes 160i of the housing 160. In this state, four metal screws 171 are fastened into the four screw holes 160i from above via the four screw holes 170b. In the fastening, the protrusion 121d of the lens holder 121 is pressed downwardly by the step portion 170a of the pressing spring 170. By performing the above operation, the lens holder 121 is pressed against the slopes 160f of the housing 160 by the urging force of the pressing spring 170, whereby the lens holder 121 is unmovable in X-axis direction (left and right directions) and in Y-axis direction (up and down directions).

As described above, when the lens holder 121 is temporarily fixed to the housing 160, there is formed a certain gap between the lens holder 121 and the inner side surface of the housing 160 so that the lens holder 121 is movable in Z-axis direction (front and rear directions).

Then, a rear surface of the laser holder 111 is abutted against the outer side surface of the housing 160 to such an extent that the CAN 110b of the laser light source 110 is inserted in the U-shaped opening 160d of the housing 160. There is formed a certain gap between the CAN 110b of the laser light source 110 and the opening 160d of the housing 160 so that the laser light source 110 is movable in X-axis direction and in Y-axis direction (up and down directions and left and right directions).

In the above state, the laser holder 111 is pressed against the housing 160 by using an XY-axes adjusting jig (not shown) to displace the laser light source 110 in X-axis direction and in Y-axis direction (up and down directions and left and right directions), whereby position adjustment in X-axis direction and in Y-axis direction (up and down directions and left and right directions) is performed. By performing the above operation, the optical axis of the laser light source 110 and the optical axis of the collimator lens 120 are aligned with each other. Further, a Z-axis adjusting jig (not shown) is engaged in the groove 121e of the lens holder 121 via the hole 160e formed in a lower portion of the housing 160, whereby position adjustment of the lens holder 121 in Z-axis direction (front and rear directions) is performed. By performing the above operation, the focal position of the collimator lens 120 is properly positioned with respect to a light emission point of the laser light source 110.

By performing the aforementioned position adjustment, an intended dot pattern is obtained in a target area.

After the position adjustment is performed as described above, a UV adhesive is applied equally in left and right directions to boundary portions between left and right two side surfaces of the laser holder 111 and the side surfaces of the housing 160. After the UV adhesive is applied, it is checked again whether there is a deviation of the optical axis of laser light. If it is confirmed that there is no problem of deviation, UV light is irradiated onto the UV adhesive, whereby the laser holder 111 is adhesively fixed to the housing 160. In the case where there is a problem of deviation of the optical axis of laser light, the position of the laser holder 111 is finely adjusted again, and UV light is irradiated onto the UV adhesive, whereby the laser holder 111 is adhesively fixed to the housing 160.

Further, the UV adhesive is applied equally in left and right directions at a position where the lens holder 121 and the slopes 160f in the inside of the housing 160 are in contact with each other via the holes 160g formed in the left and right side surfaces of the housing 160. After the application of the UV adhesive, the positional relation between the laser light source 110 and the collimator lens 120 is checked again. If it is confirmed that there is no problem of the positional relation, UV light is irradiated onto the UV adhesive, whereby the lens holder 121 is adhesively fixed to the housing 160. In the case where there is a problem of the positional relation between the laser light source 110 and the collimator lens 120, the position of the lens holder 121 is finely adjusted again, and then, UV light is irradiated onto the UV adhesive, whereby the lens holder 121 is adhesively fixed to the housing 160.

In this way, after installation of the laser light source 110 and the collimator lens 120 in the housing 160 is completed, the step portions 141b of the DOE holder 141 carrying the DOE 140 are received in the step portions 160h of the housing 160, and the DOE holder 141 is fixedly mounted in the housing 160. In this way, a structural member shown in FIG. 5B is assembled. FIG. 5B is a perspective view of a structural member before the FMD circuit board 152 is mounted in the housing 160, when viewed from a rear direction.

Thereafter, the FMD circuit board 152 carrying the FMD 150 and the capacitor 151 is positioned on the FMD mounting portion 160c in such a manner that a lower end of the FMD circuit board 152 is flush with a lower end of the FMD mounting portion 160c. Positioning the FMD circuit board 152 as described above allows a part of laser light emitted from the laser light source 110 to transmit through the leakage mirror 130 mounted on the mirror mounting portion 160a, and allows the part of laser light to enter to the FMD 150 through the opening 160b formed in the mirror mounting portion 160a. In this state, it is confirmed whether a detection signal is normally outputted from the FMD 150. If there is no problem of output, the FMD circuit board 152 is adhesively fixed to the FMD mounting portion 160c. In the case where a detection signal is not normally outputted from the FMD 150, the position of the FMD circuit board 152 is adjusted until a detection signal is normally outputted. By performing the above operation, the FMD 150 is accurately positioned to a position corresponding to the opening 160b of the housing 160, and the FMD 150 is mounted in the housing 160 in such a manner that the light receiving surface of the FMD 150 extends perpendicular to the optical axis of the laser light source 110. In this way, assembling of the light emitting device 10 is completed.

In the embodiment, as described above, the projection optical system 100 is configured to bend the optical path of laser light emitted from the laser light source 110. Accordingly, it is possible to reduce the thickness of the light emitting device 10 in Y-axis direction. In this example, there is no need of providing a photodetector for a back monitor within the CAN 110b of the laser light source 110. Accordingly, it is possible to reduce the diameter of the CAN 110b, and there is no likelihood that the thickness reduction of the light emitting device 10 is restricted by the diameter of the CAN 110b, even if the thickness reduction of the light emitting device 10 progresses.

Further, since the leakage mirror 130 is disposed with an inclination in such a direction as to reflect laser light in a direction toward a target area, a certain space can be formed on a back portion of the housing 160 where the leakage mirror 130 is mounted (see the dotted-line portion in FIG. 5B). Thus, it is possible to implement an arrangement for a front monitor system while suppressing an increase in the size of the housing 160 by disposing the FMD 150 in the space of the housing 160.

Furthermore, since the FMD 150 is disposed at a position surrounded by the back surface of the mirror mounting portion 160a and the side surface of the FMD mounting portion 160c, it is less likely that the FMD 150 may be affected by stray light from the outside of the light emitting device 10. Thus, it is possible to stably perform control of the laser light amount.

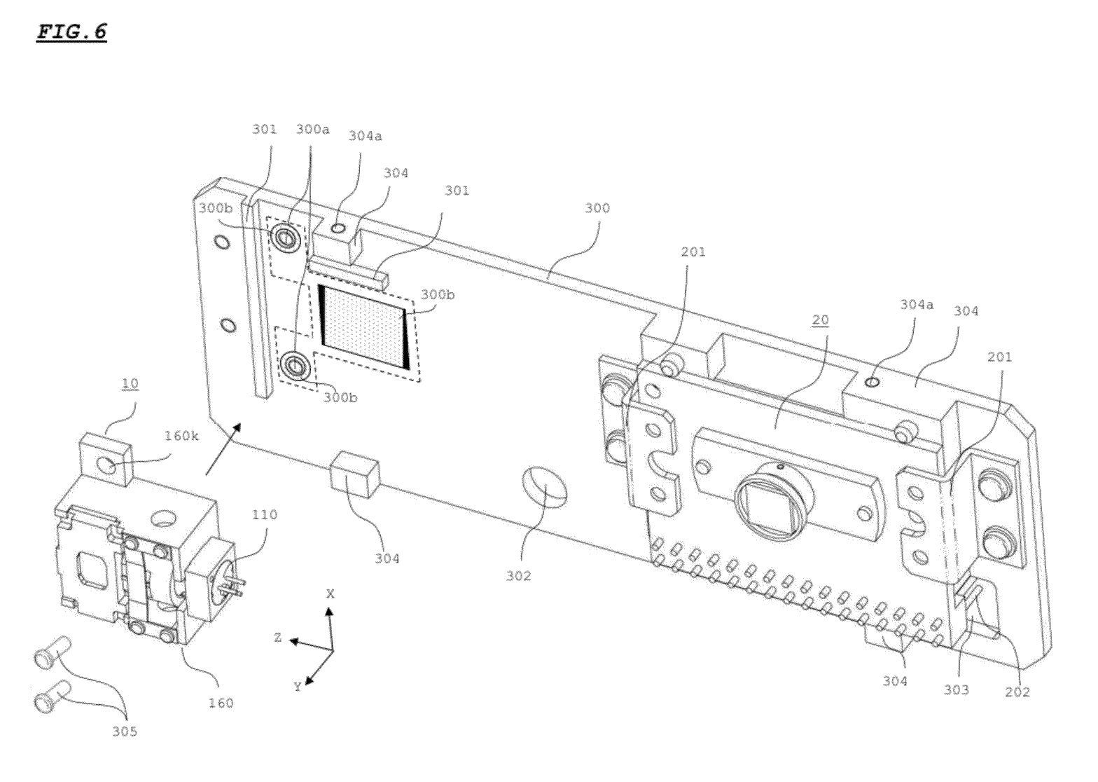

FIGS. 6 through 8B are perspective views showing an assembling process of the information acquiring device 1. To simplify the description, illustration of the assembling process of the light receiving device 20, and the mounting process of the light receiving device 20 onto the base plate 300 is omitted. The light receiving device 20 is a device constructed by assembling the light receiving optical system 200 shown in FIG. 2 and other components into one unit.

Referring to FIG. 6, the reference sign 300 denotes abase plate for supporting the light emitting device 10 and the light receiving device 20.

The light emitting device 10 and the light receiving device 20 are disposed on the base plate 300. As shown in FIG. 6, the base plate 300 has a rectangular plate-like shape. Further, the base plate 300 is made of stainless steel having a heat conductivity, and excellent flexibility resistance.

Two screw holes 300a for fixing the light emitting device 10 onto the base plate 300 are formed in the base plate 300. Further, the base plate 300 is formed with step portions 301 for determining the installation position of the light emitting device 10. The installation position of the light emitting device 10 is set in advance to such a position that the center of light emission of the light emitting device 10 and the center of light receiving of the light receiving device 20 are aligned with each other in Z-axis direction.

Further, the installation interval between the light emitting device 10 and the light receiving device 20 is set in accordance with a distance between the information acquiring device 1 and a reference plane of a target area. The distance between the reference plane and the information acquiring device 1 varies depending on a distance to a target object to be detected. As the distance to the target object to be detected decreases, the installation interval between the light emitting device 10 and the light receiving device 20 decreases. Conversely, as the distance to the target object to be detected increases, the installation interval between the light emitting device 10 and the light receiving device 20 increases.

As described above, the size of the base plate 300 increases in the alignment direction in which the light emitting device 10 and the light receiving device 20 are aligned. In the embodiment, the base plate 300 having such a large surface area is used as a heat sink for radiating heat generated in the light emitting device 10 for suppressing a temperature increase of the laser light source 110. Further, a heat radiating resin 300b is coated on a portion (see the dotted line portion in FIG. 6) of the base plate 300 which is in contact with the bottom surface of the housing 160 for enhancing the adhesiveness between the housing 160 and the base plate 300.

A hole 302 is formed in the center of a lower portion of the base plate 300 for taking out a wiring of the laser light source 110 from a back portion of the base plate 300. Further, an opening 303 for exposing a connector 202 of the light receiving device 20 from the back portion of the base plate 300 is formed in the lower portion of the base plate 300 where the light receiving device 20 is installed. Further, as shown in FIG. 6, flange portions 304 are formed on the base plate 300, and screw holes 304a for fixing a cover 400 to be described later onto the base plate 300 are formed in the flange portions 304.

As shown in FIG. 2, the light receiving device 20 is provided with the filter 210, the aperture 220, the imaging lens 230, and the CMOS image sensor 240. The light receiving device 20 is fixed onto the base plate 300 by a substrate fixing portion 201. The connector 202 of the light receiving device 20 is exposed from a back surface of the base plate 300 via the opening 303 formed in the base plate 300.

The light emitting device 10 is disposed at such a position that the side surface of the housing 160 is in contact with the step portions 301 of the base plate 300. The light emitting device 10 is configured in such a manner that the bottom surface of the housing 160 is firmly adhered to the base plate 300 by the heat radiating resin 300b coated on the surface of the base plate 300. In this state, the two screw holes 300a and the two screw holes 160k are aligned with each other, and the two metal screws 305 are fastened into the two respective screw holes 160k and into the two respective screw holes 300a. The screws 305 are made of a metal having a high heat conductivity such as stainless steel. By performing the above operation, the light emitting device 10 is fixedly mounted onto the base plate 300.

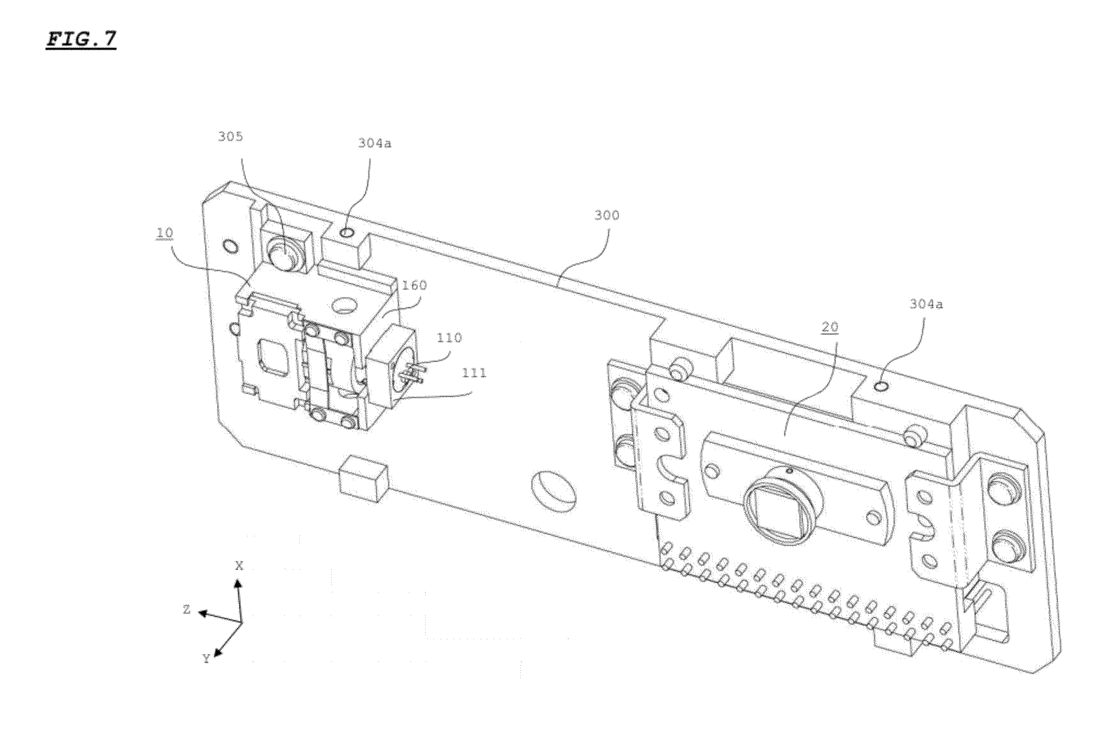

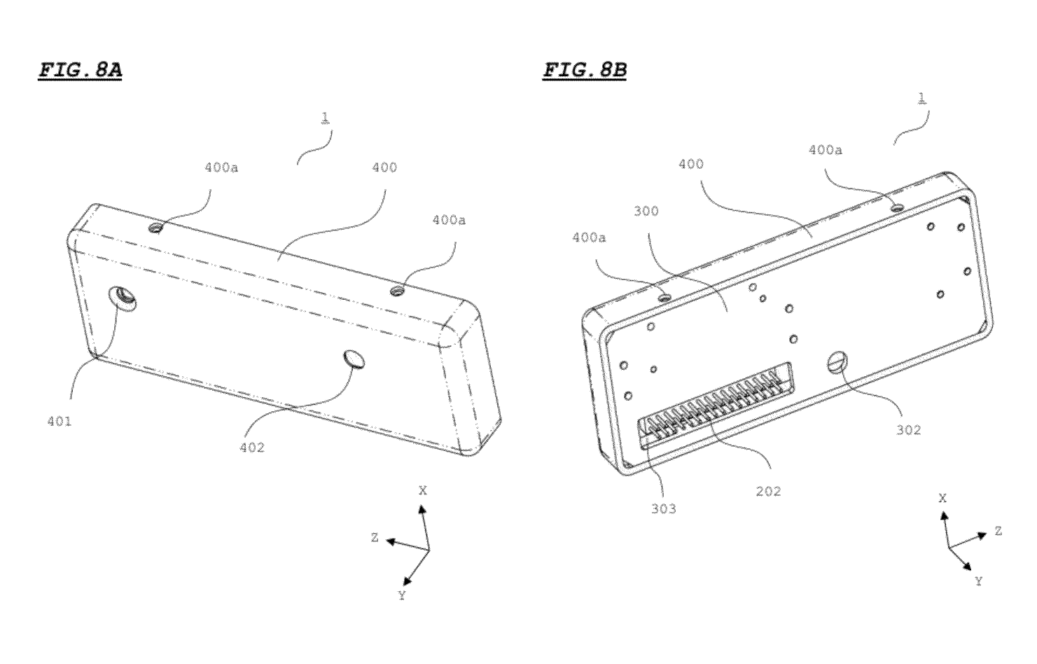

In this way, a structural member shown in FIG. 7 is assembled. Thereafter, the cover 400 is mounted on the structural member (see FIG. 8A). In the mounting, the screw holes 304a of the base plate 300, and screw holes 400a of the cover 400 are aligned with each other, and the cover 400 is screw-fastened to the base plate 300. By performing the above operation, the assembling of the structural member shown in FIGS. 8A and 8B is completed. FIG. 8A is a perspective view of the structural member when viewed from front side, and FIG. 8B is a perspective view of the structural member when viewed from back side.

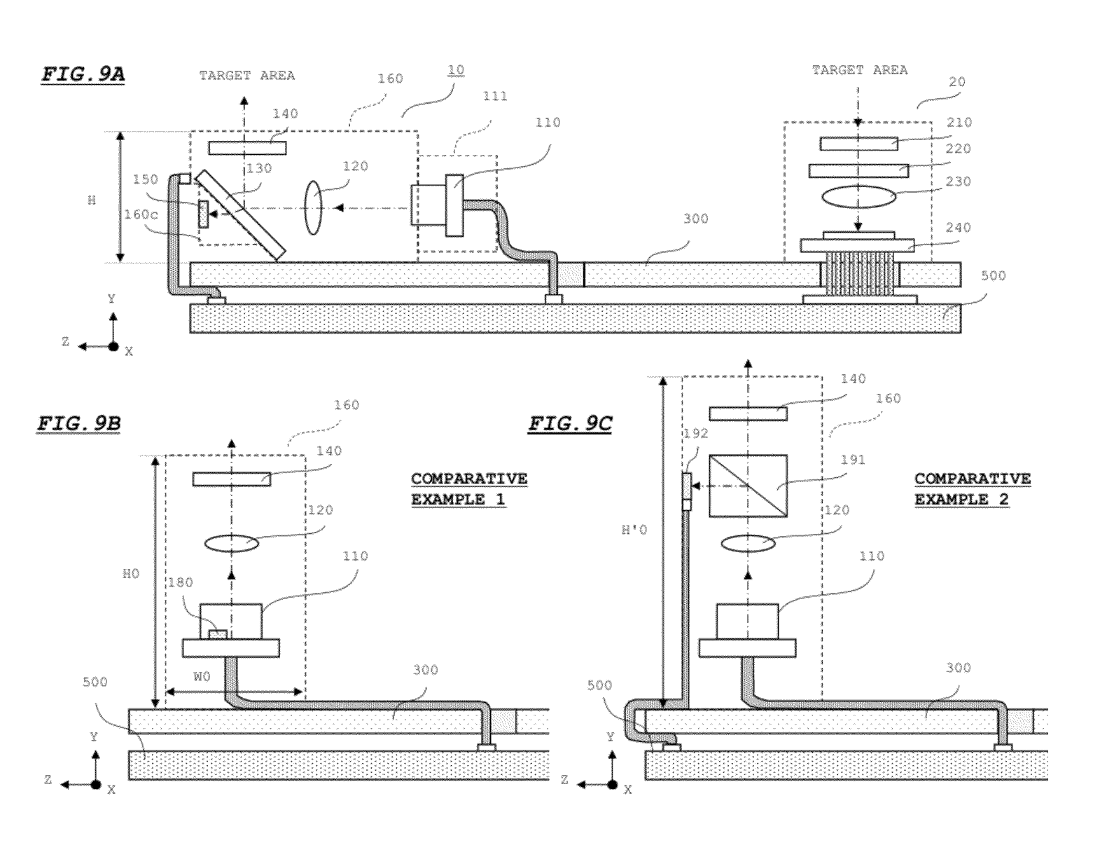

A light projecting window 401 for guiding light emitted from the light emitting device 10 to a target object, and a light receiving window 402 for guiding reflected light from the target object to the light receiving device 20 are formed in a front surface of the cover 400. Further, a circuit board 500 (see FIG. 9A) is mounted on the back surface of the base plate 300 (not shown in FIGS. 8A and 8B). The laser light source 110 is connected to the circuit board 500 via the hole 302 formed in the back portion of the base plate 300. Further, the circuit board 500 is connected to the connector 202 of the light receiving device 20 via the opening 303 formed in the back portion of the base plate 300. Further, the circuit board 500 is connected to an FPC 152a of the FMD circuit board 152 which is drawn from the gap between the side surface of the base plate 300 and the cover 400. The circuit section of the information acquiring device 1 such as the CPU 21 and the laser driving circuit 22 shown in FIG. 2 is mounted on the circuit board 500.

FIGS. 9A and 9B are schematic diagrams respectively showing an arrangement of the light emitting device 10 in the embodiment, and an arrangement of a light emitting device in a comparative example.

Referring to FIG. 9A, as described above, the laser light source 110 in the embodiment is disposed in such a manner that the optical axis of emission light extends in parallel to Z-axis. Laser light emitted from the laser light source 110 is collimated into substantially parallel light by the collimator lens 120. Then, a main part of laser light transmitted through the collimator lens 120 is reflected in plus Y-axis direction by the leakage mirror 130 and entered to the DOE 140, and a part of the laser light is transmitted through the leakage mirror 130 and entered to the FMD 150. In this way, in the embodiment, the laser light source 110, the collimator lens 120, and the leakage mirror 130 in the projection optical system 100 are aligned along the surface of the base plate 300. Thus, it is possible to significantly reduce the height H of the housing 160 in a direction (plus Y-axis direction) toward a target area.

On the other hand, in the comparative example 1 shown in FIG. 9B, in the case where optical elements of a projection optical system 100 are aligned in a direction toward a target area, it is possible to widen the width WO of a housing 160. Accordingly, in this arrangement, it is possible to dispose a laser light source 110 having a large diameter and provided with a back monitor 180 in a CAN. However, in this arrangement, since all the optical elements of the projection optical system 100 are aligned in the direction toward the target area, the height HO of the housing 160 is considerably high, as compared with the height H of the housing 160 in the embodiment.

Normally, a front monitor system is advantageous in providing high-speed responsiveness, as compared with a back monitor system, and is capable of performing APC control with high precision. If the arrangement of the front monitor system is applied to the projection optical system 100 as shown in FIG. 9B for taking advantage of this merit, as shown in the comparative example 2 of FIG. 9C, it is necessary to dispose a light separating element such as a half mirror 191 in a projection optical path, as an additional element. In this arrangement, the height H′0 of a housing 160 is even higher than the arrangement shown in the comparative example 1.

Referring back to FIG. 9A, in the embodiment, a part of laser light can be guided to the FMD 150 by the leakage mirror 130, and it is not necessary to prepare an additional light separating element, as shown in the comparative example 2 of FIG. 9C. Further, it is possible to dispose the FMD 150 in a space behind the leakage mirror 130 which is disposed with an inclination of 45 degrees in an in-plane direction of Y-Z plane with respect to X-Z plane. As described above, in the embodiment, it is possible to implement an arrangement of a front monitor system for APC control, while reducing the thickness of the light emitting device 10.

FIG. 10 is a diagram showing an APC control processing. The processing shown in FIG. 10 is performed by the APC controller 21b shown in FIG. 2.

Referring to FIG. 10, at a certain timing of laser light emission by the laser controller 21a (S101: YES), the APC controller 21b acquires a PD signal in accordance with a received light amount, which is outputted from the PD signal processing circuit 23 (S102). Then, the APC controller 21b determines whether the received light amount of the FMD 150 lies in a predetermined light amount range, based on a value of the acquired PD signal (S103). The predetermined light amount range is defined by two threshold values corresponding to an upper limit and a lower limit of a proper light emission amount of the laser light source 110. These two threshold values are held in advance in the memory 26.

If the received light amount lies in the predetermined light amount range (S103: YES), the APC controller 21b determines that laser light of a proper light emission amount is emitted from the laser light source 110, and the processing is proceeded to S107. On the other hand, in the case where the received light amount does not lie in the predetermined light amount range (S103: NO), the APC controller 21b determines that laser light of an improper light emission amount is emitted from the laser light source 110, and determines whether the received light amount is larger than the predetermined light amount (S104).

In the case where the received light amount is larger than the predetermined light amount (S104: YES), the APC controller 21b outputs a signal, to the laser controller 21a, for decrementing the light emission amount of laser light to be emitted from the laser light source 110 by one step (S105). In response to receiving the signal, the laser controller 21a decrements the light emission amount from the laser light source 110 by one step. Thereby, the light emission amount from the laser light source 110 is decremented by one step.

In the case where the received light amount is smaller than the predetermined light amount (S104: NO), the APC controller 21b outputs, to the laser controller 21a, a signal for incrementing the light emission amount of laser light to be emitted from the laser light source 110 by one step (S106). In response to receiving the signal, the laser controller 21a increments the light emission amount from the laser light source 110 by one step. Thereby, the light emission amount from the laser light source 110 is incremented by one step.

Thereafter, it is determined whether it is the timing when laser light emission is to be terminated (S107). In the case where it is not the timing when laser light emission is to be terminated (S107: NO), the processing (S102 through 5107) of adjusting the light emission amount of the laser light source 110 is repeated. When it is the timing when laser light emission is to be terminated (S107: YES), the APC controller 21b terminates the APC control processing, and the routine returns to S101 and waits for a next light emission timing.

As described above, in the embodiment, the optical elements from the laser light source 110 to the leakage mirror 130 are aligned in parallel to the surface of the base plate 300. Accordingly, the height of the housing 160 for housing the projection optical system 100 decreases in a direction toward a target area. Further, since the leakage mirror 130 is disposed with an inclination for reflecting laser light in a direction toward a target area, a certain space can be formed on a rear portion of the housing 160 carrying the leakage mirror 130. By disposing the FMD 150 in the space, it is possible to perform APC control of the laser light source 110, while suppressing an increase in the size of the housing 160.

Further, in the embodiment, since the FMD 150 is disposed at a position surrounded by the outer side surface of the housing 160, it is possible to suppress an influence of stray light from the outside of the light emitting device 10. Thereby, it is possible to stably perform APC control of the laser light source 110.

Further, in the embodiment, since the leakage mirror 130 functions as an optical path changing element for bending the optical path of laser light, and a light separating element for guiding a part of laser light to the FMD 150, it is possible to reduce the number of parts.

Further, in the embodiment, it is possible to suppress a loss in the light amount of laser light to be projected onto a target area by using the leakage mirror 130 having a high reflectance and a low transmittance. Further, it is possible to suppress an influence of optical feedback that is reflected on the surface of the FMD 150 and returns to the laser light source 110.

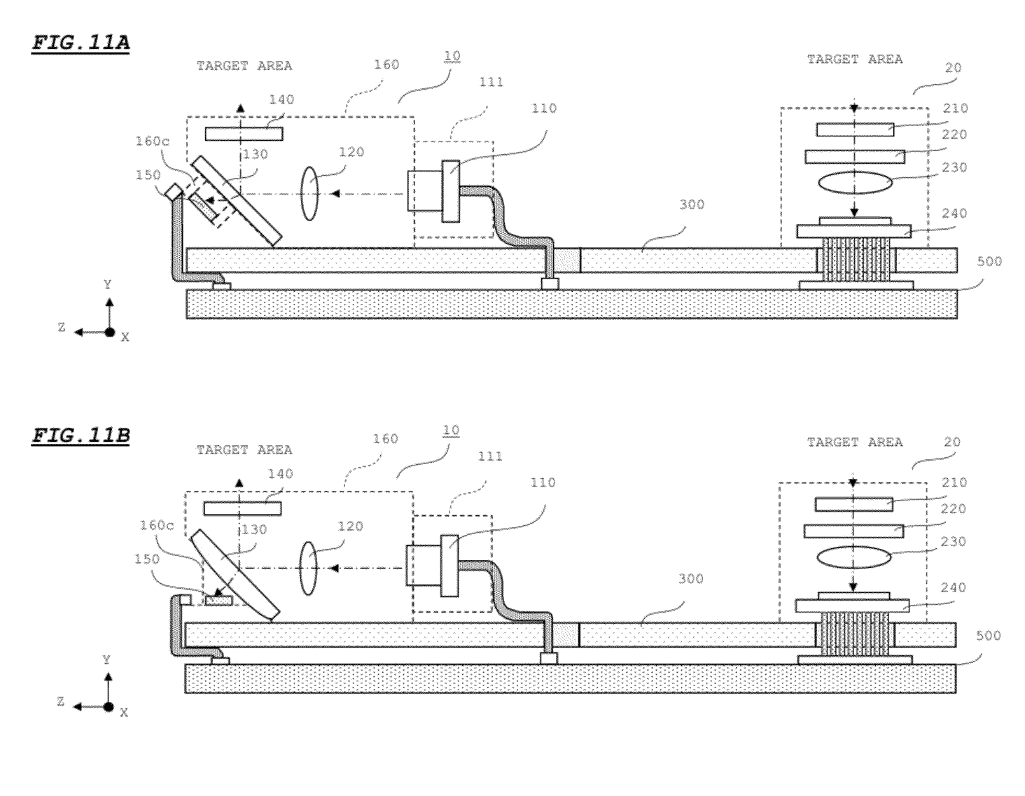

The embodiment of the invention has been described as above. The invention is not limited to the foregoing embodiment, and the embodiment of the invention may be changed or modified in various ways other than the above. For instance, in the embodiment, the FMD mounting portion 160c is provided in such a manner that a light receiving surface of the FMD 150 extends perpendicular to the optical axis of the laser light source 110. Alternatively, as shown in FIG. 11A, the FMD mounting portion 160c may be formed in such a manner that the light receiving surface of the FMD 150 extends in parallel to the back surface of the leakage mirror 130. Further alternatively, as shown in FIG. 11B, the FMD mounting portion 160c may be formed in such a manner that the light receiving surface of the FMD 150 extends in parallel to the light incident surface of the DOE 140. In the latter modification, however, the light exit surface of the leakage mirror 130 may be formed into e.g. a curved surface so that laser light is directed toward the light receiving surface of the FMD 150 after transmitting through the leakage mirror 130. In the modification examples shown in FIGS. 11A and 11B, laser light is entered to the light receiving surface of the FMD 150 with an inclination, there is no likelihood that optical feedback in laser light reflected on the light receiving surface of the FMD 150 may return along the optical path at the time of light incidence, and it is possible to reduce an influence of optical feedback with respect to the laser light source 110, although a detection signal may be slightly degraded.

Further, in the embodiment, the U-shaped opening 160b is formed in the mirror mounting portion 160a of the housing 160. Alternatively, the opening 160b may have a circular shape or other shape. Further alternatively, the mirror mounting portion 160a may be formed to support the side surface of the leakage mirror 130 and only a part of the back surface of the leakage mirror 130 near the side surface of the leakage mirror 130 so that the mirror mounting portion 160a does not exist on a main part of the back surface side of the leakage mirror 130.

Further, in the embodiment, there is used the leakage mirror 130 whose reflectance is considerably larger than the transmittance for reflecting a main part of laser light to be emitted toward Z-axis direction in a direction toward the DOE 140, and for transmitting a part of the laser light in a direction toward the FMD 150. Alternatively, a half mirror whose reflectance and transmittance are substantially equal to each other, or a polarized beam splitter for separating laser light by a polarization direction may be used, in place of the leakage mirror 130.

Further, in the embodiment, the laser holder 111 for housing the laser light source 110 is provided. Alternatively, the laser light source 110 may be directly housed in the housing 160.

Further, in the embodiment, the mirror mounting portion 160a is formed in such a manner that the leakage mirror 130 is inclined at 45° in an in-plane direction of Y-Z plane. Alternatively, the mirror may be inclined in any direction in accordance with a direction of a target area. Further alternatively, the inclination angle may be optionally changed.

Further, in the embodiment, the CMOS image sensor 240 is used as a light receiving element. Alternatively, a CCD image sensor may be used in place of the CMOS image sensor 240. Further alternatively, the arrangement of the light receiving optical system 200 may be modified, as necessary. Further alternatively, the information acquiring device 1 and the information processing device 2 may be integrally configured into one unit, or the information acquiring device 1 and the information processing device 2 may be integrally configured with a television, a game machine, or a personal computer.

The embodiment of the invention may be changed or modified in various ways as necessary, as far as such changes and modifications do not depart from the scope of the claims of the invention hereinafter defined.

What is claimed is:

1. An information acquiring device, comprising:
a light emitting device which irradiates a target area with laser light having a dot pattern;
a light receiving device which captures an image of the target area; and
a base member on which the light emitting device and the light receiving device are mounted side by side,
the light emitting device including:
a laser light source;
a collimator lens which converts laser light emitted from the laser light source into parallel light;
a light separating element which reflects a part of the laser light transmitted through the collimator lens, and transmits a part of the laser light;
a diffractive optical element which converts the laser light reflected on the light separating element into laser light having a predetermined dot pattern in the target area for projecting onto the target area;
a photodetector which receives the laser light transmitted through the light separating element for outputting a detection signal in accordance with a received light amount; and
a laser controller which controls a light emission amount of the laser light source, based on the detection signal from the photodetector, wherein
the light emitting device is configured to dispose the laser light source, the collimator lens, the light separating element, the photodetector and the diffractive optical element on the base member in such a manner that the laser light source, the collimator lens and the light separating element are linearly arranged, and that the diffractive optical element faces the target area.

2. The information acquiring device according to claim 1, further comprising:
a housing which holds the laser light source, the collimator lens, the light separating element, the photodetector and the diffractive optical element therein, wherein
the housing is mounted on the base member.

3. The information acquiring device according to claim 2, wherein
the housing includes a light separating element holding portion which holds the light separating element with an inclination with respect to an optical axis of the laser light source, and a photodetector holding portion which is disposed in a direction away from the laser light source with respect to the light separating element holding portion and holds the photodetector, and
the light separating element holding portion is formed with an opening for guiding the laser light to the photodetector by passing the laser light transmitted through the light separating element.

4. The information acquiring device according to claim 3, wherein
the photodetector holding portion is formed in a space to be formed by holding the light separating element obliquely, the space being formed on a back surface side of the light separating element holding portion.

5. The information acquiring device according to claim 1, wherein
the photodetector is disposed in such a manner that a light receiving surface thereof extends perpendicular to an optical axis of the laser light source.

6. An object detecting device, comprising:
an information acquiring device,
the information acquiring device including:
a light emitting device which irradiates a target area with laser light having a dot pattern;
a light receiving device which captures an image of the target area; and
a base member on which the light emitting device and the light receiving device are mounted side by side,
the light emitting device including:
a laser light source;
a collimator lens which converts laser light emitted from the laser light source into parallel light;
a light separating element which reflects a part of the laser light transmitted through the collimator lens, and transmits a part of the laser light;
a diffractive optical element which converts the laser light reflected on the light separating element into laser light having a predetermined dot pattern in the target area for projecting onto the target area;
a photodetector which receives the laser light transmitted through the light separating element for outputting a detection signal in accordance with a received light amount; and
a laser controller which controls a light emission amount of the laser light source, based on the detection signal from the photodetector, wherein
the light emitting device is configured to dispose the laser light source, the collimator lens, the light separating element, the photodetector and the diffractive optical element on the base member in such a manner that the laser light source, the collimator lens and the light separating element are linearly arranged, and that the diffractive optical element faces the target area.

7. The object detecting device according to claim 6, further comprising:
a housing which holds the laser light source, the collimator lens, the light separating element, the photodetector and the diffractive optical element therein, wherein
the housing is mounted on the base member.

8. The object detecting device according to claim 7, wherein
the housing includes a light separating element holding portion which holds the light separating element with an inclination with respect to an optical axis of the laser light source, and a photodetector holding portion which is disposed in a direction away from the laser light source with respect to the light separating element holding portion and holds the photodetector, and
the light separating element holding portion is formed with an opening for guiding the laser light to the photodetector by passing the laser light transmitted through the light separating element.

9. The object detecting device according to claim 8, wherein
the photodetector holding portion is formed in a space to be formed by holding the light separating element obliquely, the space being formed on a back surface side of the light separating element holding portion.

10. The object detecting device according to claim 6, wherein
the photodetector is disposed in such a manner that a light receiving surface thereof extends perpendicular to an optical axis of the laser light source.
